(19) United States
(12) Patent Application Publication
(10) Pub. No.: US 2026/0291085 A1
(43) Pub. Date: Sep. 24, 2026

(54) LOW BAND AND MID BAND SPLIT SECTOR ANTENNA

(71) Applicant: JOHN MEZZALINGUA ASSOCIATES, LLC., Syracuse, NY (US)

(72) Inventors: Ravi Kumar MUTHYALA, Plano, TX (US); Wengang CHEN, Jamesville, NY (US); Gilberto Guerra ARIAS, Denton, TX (US); Mark MONTGOMERY, Van Alstyne, TX (US); Naveena APPARI, Lavon, TX (US); Taehee JANG, Allen, TX (US)

(21) Appl. No.: 19/571,116

(22) Filed: Mar. 18, 2026

Related U.S. Application Data
(60) Provisional application No. 63/773,531, filed on Mar. 18, 2025.

(51) Int. Cl. H01Q 21/06; H01Q 1/24; H01Q 19/18

(52) U.S. Cl. CPC H01Q 21/062; H01Q 1/246; H01Q 19/18

(57) ABSTRACT

A split sector antenna comprises a first array face having a first plurality of first dipoles and a first plurality of second dipoles disposed on a first reflector, the first reflector having a plurality of first interlocking extensions, wherein disposed on each of the plurality of first interlocking extensions is a second dipole; and a second array face having a second plurality of first dipoles and a second plurality of second dipoles disposed on a second reflector, the second reflector having a plurality of second interlocking extensions, wherein disposed on each of the plurality of second interlocking extensions is a second dipole, wherein the first array face is mounted at a first azimuth angle, and wherein the second array face is mounted at a second azimuth angle.

### CROSS-REFERENCE TO RELATED APPLICATION

This application claims the benefit of U.S. Provisional Application No. 63/773,531, filed Mar. 18, 2025, which is hereby incorporated by reference in its entirety.

### BACKGROUND OF THE INVENTION

Split sector cellular antennas provide two adjacent coverage sectors from within a single antenna structure. A disadvantage of conventional split sector antennas is that the reflector for a given sector in narrower than would be for a macro antenna that is not a split sector antenna. A narrower reflector limits the beam quality for the Mid Band (1698-2700 MHz), and more particularly for the Low Band (698-894 MHz).

### SUMMARY OF THE INVENTION

An aspect of the disclosure involves a split sector antenna. The split sector antenna comprises a first array face having a first plurality of first dipoles and a first plurality of second dipoles, the first plurality of first dipoles and the first plurality of second dipoles disposed on a first reflector, the first reflector having a plurality of first interlocking extensions, wherein disposed on each of the plurality of first interlocking extensions is a second dipole; and a second array face having a second plurality of first dipoles and a second plurality of second dipoles, the second plurality of first dipoles and the second plurality of second dipoles disposed on a second reflector, the second reflector having a plurality of second interlocking extensions, wherein disposed on each of the plurality of second interlocking extensions is a second dipole, wherein the first array face is mounted at a first azimuth angle, and wherein the second array face is mounted at a second azimuth angle, and wherein the first dipoles are configured to radiate at a first frequency and the second dipoles are configured to radiate at a second frequency, the second frequency being lower than the first frequency.

### BRIEF DESCRIPTION OF DRAWINGS

FIG. 1A illustrates an exemplary split sector array face assembly according to the disclosure.

FIG. 1B is an ortho (i.e., orthographic) view of the split sector array face assembly of FIG. 1A.

FIG. 2A illustrates an exemplary radome from along the elevation axis.

FIG. 2B is an ortho view of the radome of FIG. 2A.

FIG. 3A illustrates an exemplary split sector array assembly within the radome from along the elevation axis.

FIG. 3B illustrates an exemplary split sector array assembly (without radome) from along the elevation axis.

FIG. 3C illustrates one array face, showing the spacing of Low Band dipoles parallel to the reflector, along the azimuth axis.

FIG. 4A illustrates exemplary reflectors for first and second sector array faces according to the disclosure.

FIG. 4B illustrates exemplary first and second sector array faces according to the disclosure.

FIG. 5 illustrates exemplary array face configurations for the first and second sector arrays according to the disclosure

FIG. 6 illustrates another exemplary split sector array face assembly according to the disclosure.

### DETAILED DESCRIPTION OF THE INVENTION

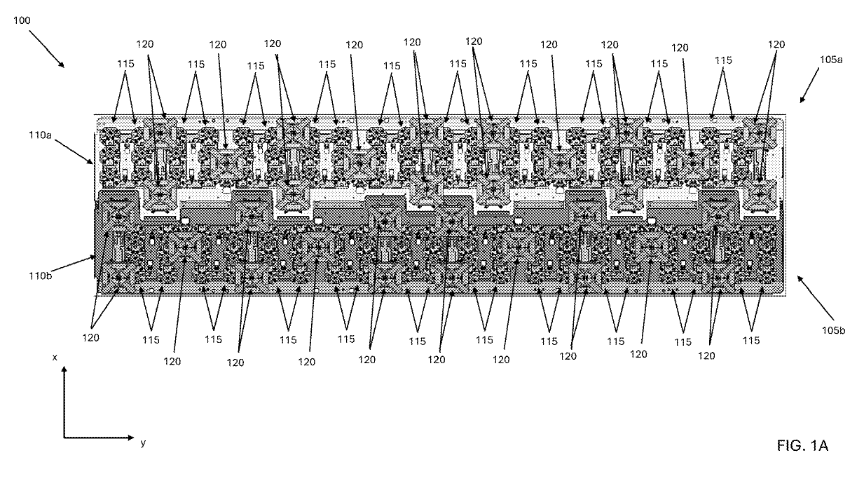

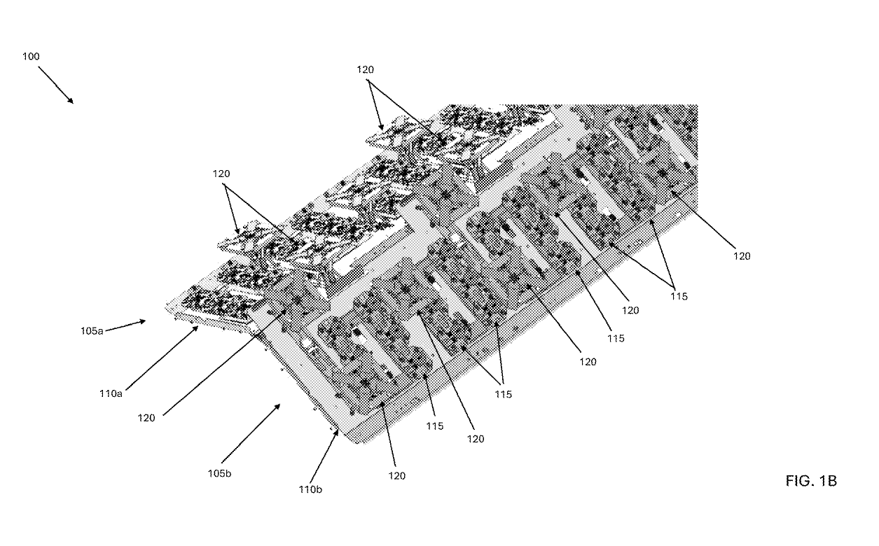

FIG. 1A illustrates an exemplary split sector array face assembly 100 according to the disclosure (hereinafter “array face assembly 100”). Array face assembly 100 is shown “on its side” for the convenience of illustration, whereby the elevation axis (y-axis) is shown as horizontal and the azimuth axis (x-axis) is shown as vertical. It will be understood that array face assembly 100 would typically be mounted such that the elevation axis is vertical and the azimuth axis is horizontal.

Array face assembly 100 has two array faces 105a and 105b that are mounted adjacent to each other along the elevation axis. Each array face 105a/105b has a respective reflector plate 110a/110b, on which are disposed a plurality of Mid Band dipoles 115 and Low Band dipoles 120. For each array face 105a/b the Mid Band dipoles 115 are arranged in twenty rows of three dipoles 115, each row being parallel to the azimuth axis. Also disposed on each array face 105a/105b is a plurality of Low Band dipoles 120 that are arranged in ten rows, each row being parallel to the azimuth axis, where the second, fourth, seventh, and ninth rows (starting from either end of the array face 105a/b) have a single Low Band dipole 120 disposed at or near the center of reflector 110a/b, and where the first, third, fifth, sixth, eigth, and tenth rows have two Low Band dipoles 120 disposed at opposite edges of reflector 110a/b along the azimuth axis. Although exemplary array face assembly 100 has twenty rows of Mid Band 115 dipoles and ten rows of Low Band dipoles 120, it will be understood that variations to the number of rows and number of locations are possible and within the scope of the disclosure.

FIG. 1B is an ortho view of array face assembly 100, providing further detail of the placement of Mid Band dipoles 115 and Low Band dipoles 120 on reflectors 110a/110b, as well as the mounting angles of array faces 105a/105b. Also shown are the interlocking edges of reflectors 105a/105b.

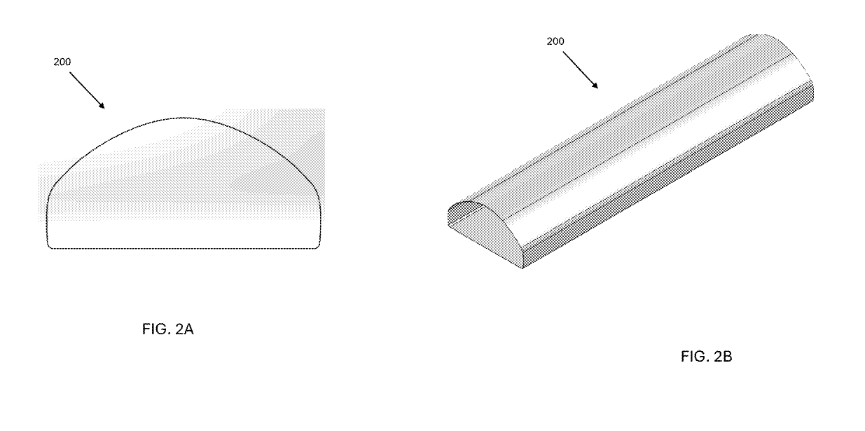

FIG. 2A Illustrates an exemplary radome 200, which houses array face assembly 100 (not shown). The view in FIG. 2A is from along the elevation axis.

FIG. 2B is an ortho view of radome 200.

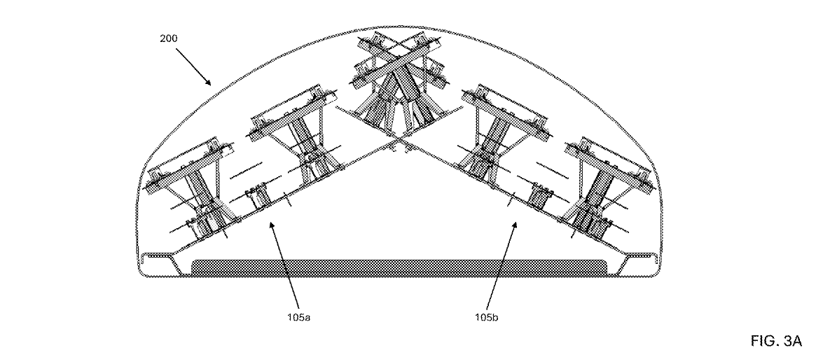

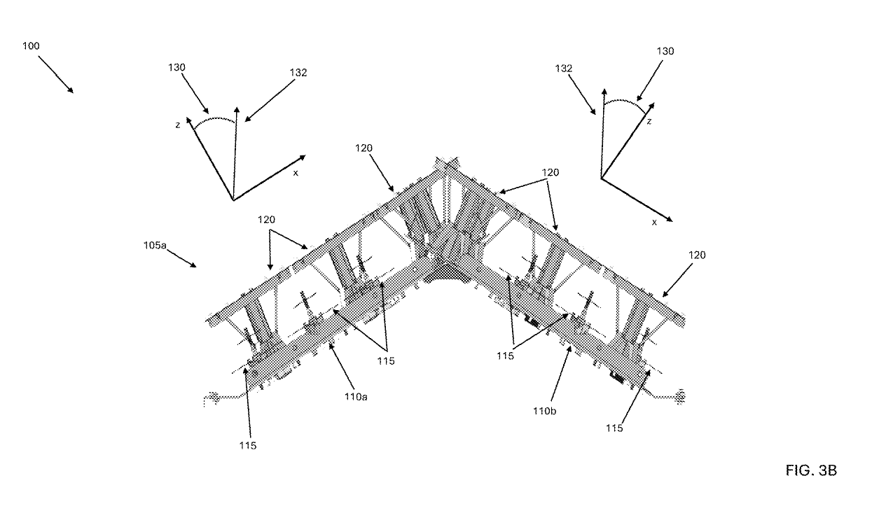

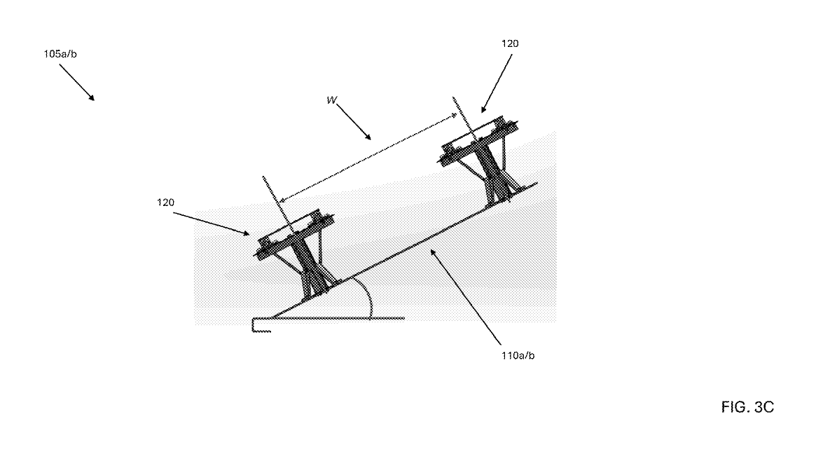

FIG. 3A illustrates array face assembly 100 housed within radome 200. Shown are array faces 105a and 105b, mounted at their respective angles, as viewed from along the elevation axis.

FIG. 3B illustrates array face assembly 100 from along the elevation axis. Shown are reflectors 110a/110b, which are mounted at angles 130 relative to a mounting normal vector 132, whereby mounting normal vector 132 may be defined as a reference to the boresight of array face assembly 100. In an exemplary embodiment, azimuth angle 130 is 27 degrees, whereby boresight axis (z-axis) of array face 105a is at an azimuth angle of -27 degrees (azimuth angle being relative to mounting normal vector 132) and boresight axis (z-axis) of array face 105b is at an azimuth angle of +27 degrees. Disposed on reflectors 110a/110b are Mid Band dipoles 115, each in rows of three, and Low Band dipoles 120. It will be understood that other values for angle 130 are possible and within the scope of the disclosure, depending on the design of array faces 105a/b and the width of the gain pattern for the Mid Band and the Low Band, among other things.

FIG. 3C illustrates a single array face 105a/b, showing only Low Band dipoles 120 that are arranged with two dipoles in a row on reflector 110a/b, such as the second, fourth, seventh and ninth rows of FIG. 1A. In exemplary array face 105a/b, the two Low Band dipoles 120 may be separated by a distance W. For array faces 105a/b, distance W may be 240mm. This distance provides for sufficient array factor to control the beam width and beam quality in the Low Band gain pattern (not shown) of array face 105a/b.

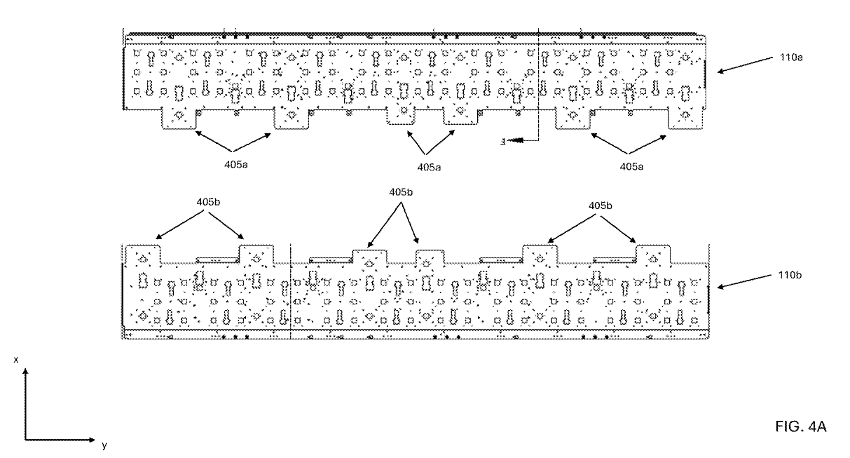

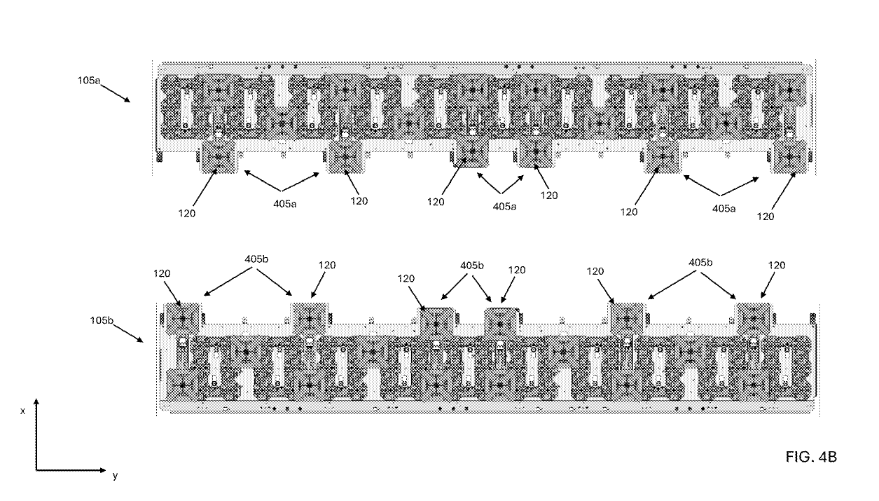

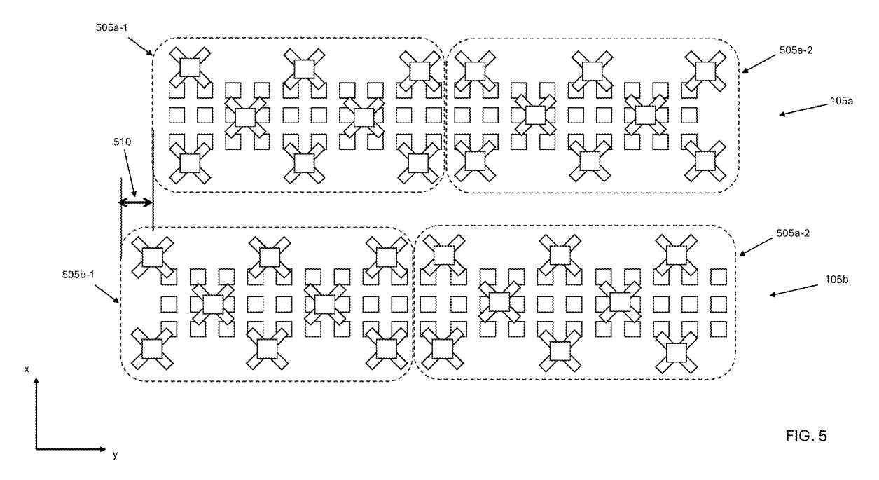

FIG. 4A illustrates reflectors 110a/110b of respective array faces 105a/105b according to the disclosure. Reflector 110a has a plurality of interlocking extensions 405a, each of which serves as a reflector platform for a Low Band dipole 120, enabling the Low Band dipoles 120 that share a row to be separated as far as possible to enable array factor to improve the Low Band beam quality and control Low Band beam width. Reflector 110b has a plurality of interlocking extensions 405b, which provide the same Low Band beam quality benefit as interlocking extensions 405a or reflector 110a.

FIG. 4B illustrates exemplary array faces 105a/b according to the disclosure, showing the placement of Low Band dipoles 120 on interlocking extensions 405a/b. Interlocking extensions 205a/b enable sufficient separation of Low Band dipoles 120 in the azimuth (x) direction to enable an array factor that improves beam quality. Further, by staggering the locations of interlocking extensions 405a relative to interlocking extensions 405b, array faces 105a/b may be mechanically coupled adjacent to each other, making optimal use of the volume within the antenna radome (not shown).

FIG. 5 illustrates exemplary array face configurations for the array faces 105a/b according to the disclosure. Array face 105a has array face segments 505a-1 and 505a-2, which are identical and disposed adjacent to each other along the elevation (y) axis. Array face 105b has array face segments 505b-1 and 505b-2, which are identical and disposed adjacent to each other along the elevation (y) axis. The combination of array face segments 505a-1/505a-2, and the combination of array face segments 505b-1/505b-2 may be positioned relative to each other along the elevation (y) axis at an offset 510. Array face cluster 505a-1/505a-2/505b-1/505b-2 may be identical, which enables array faces 105a/b to have identical gain patterns, offset by mounting angles 130.

Offset 510 enables interlocking extensions 405a/b to interlink when reflectors 110a/b are mechanically coupled together.

Exemplary array face 100 supports eight ports of Low Band signals and eight ports of Mid Band signals. Each array face segment 505a-1/505a-2/505b-1/505b-2 is allocated two Low Band ports (one per polarization of Low Band dipole 120) and two Mid Band ports (one per polarization of Mid Band dipole 115). It will be understood that other port/dipole configurations are possible and within the scope of the disclosure.

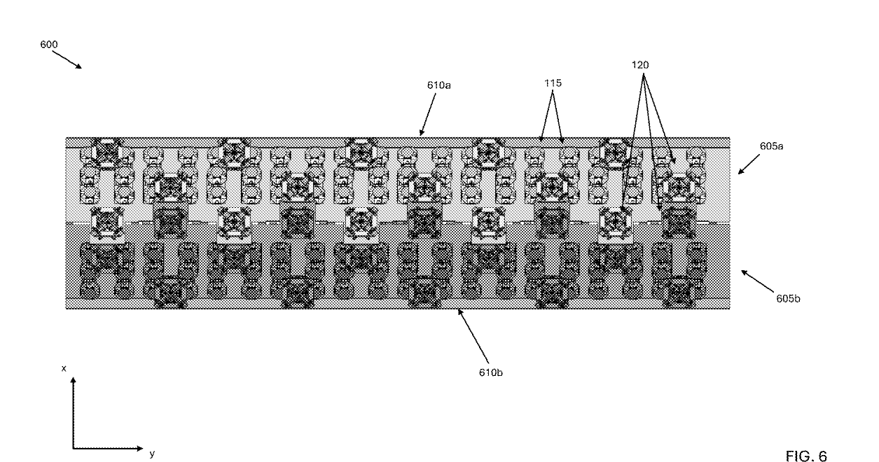

FIG. 6 illustrates another exemplary split sector array face assembly 600 according to the disclosure. Array face assembly 600 has array faces 605a and 605b, which are designed so that they do not have an offset 510 present in array face assembly 100. Low Band dipoles 120 on each array face 610a/b are arranged such that they alternate along the elevation (y) axis between a single Low Band dipole 120 and a pair of Low Band dipoles 120. The pair of Low Band dipoles 120 are spaced apart in the azimuth direction to provide array factor, as described with reference to FIG. 3C. Reflectors 610a and 610b have respective extensions on which is disposed a single Low Band dipole 120, which is the Low Band dipole 120 of the pair illustrated in FIG. 3C disposed adjacent to the other array face 105a/b.

For array face assembly 600, array faces 605a/b may have their Low Band dipoles 120 spaced apart in the azimuth direction, referred to distance W in FIG. 3C, at a distance of 280mm.

1. A split sector antenna, comprising:
a first array face having a first plurality of first dipoles and a first plurality of second dipoles, the first plurality of first dipoles and the first plurality of second dipoles disposed on a first reflector, the first reflector having a plurality of first interlocking extensions, wherein disposed on each of the plurality of first interlocking extensions is one of the first plurality of second dipoles; and
a second array face having a second plurality of first dipoles and a second plurality of second dipoles, the second plurality of first dipoles and the second plurality of second dipoles disposed on a second reflector, the second reflector having a plurality of second interlocking extensions, wherein disposed on each of the plurality of second interlocking extensions is one of the second plurality of second dipoles,
wherein the first array face is mounted at a first azimuth angle, and wherein the second array face is mounted at a second azimuth angle,
and wherein the first dipoles are configured to radiate at a first frequency and the second dipoles are configured to radiate at a second frequency, the second frequency being lower than the first frequency.

2. The split sector antenna of claim 1, wherein the first azimuth angle and the second azimuth angle are of equal magnitude.

3. The split sector antenna of claim 2, wherein the first azimuth angle is -27 degrees relative to a mounting normal vector, and the second azimuth angle is +27 degrees relative to the mounting normal vector.

4. The split sector antenna of claim 1, wherein the first and the second array faces are disposed along the elevation axis with an offset relative to each other along the elevation axis.

5. The split sector antenna of claim 1, wherein the first array face comprises a first plurality of array face segments disposed adjacent to each other along an elevation axis.

6. The split sector antenna of claim 5, wherein the second array face comprises a second plurality of array face segments disposed adjacent to each other along the elevation axis.

7. The split sector antenna of claim 6, wherein the first plurality of array face segments and the second plurality of array face segments are disposed along the elevation axis such that they have a relative offset along the elevation axis.

8. The split sector antenna of claim 5, wherein each of the array face segments are configured to radiate two signals in the first frequency and two signals in the second frequency.

9. The split sector antenna of claim 1, wherein the first frequency comprises a Mid Band frequency and the second frequency comprises a Low Band frequency.

10. A split sector antenna comprising:
a first array face having a first plurality of first dipoles and a first plurality of second dipoles, the first plurality of first dipoles and the first plurality of second dipoles disposed on a first reflector of the first array face, the first reflector having a plurality of first interlocking extensions and disposed on each of the plurality of first interlocking extensions is respective one of the first plurality of second dipoles; and
a second array face having a second plurality of first dipoles and a second plurality of second dipoles, the second plurality of first dipoles and the second plurality of second dipoles disposed on a second reflector, the second reflector having a plurality of second interlocking extensions and disposed on each of the plurality of second interlocking extensions is a respective one of the second plurality of Low Band dipoles,
wherein the first array face is mounted at a first azimuth angle, and the second array face is mounted at a second azimuth angle, and
wherein the plurality of first interlocking extensions and the plurality of second interlocking extensions are configured such that a distance between the one second dipole disposed on its respective one of the first interlocking extensions and another, corresponding one of the first plurality of second dipoles and a distance between the one second dipole disposed on its respective one of the plurality of second interlocking extensions and another, corresponding one of the second plurality of second dipoles ensure array factor.

11. The split sector antenna of claim 10, wherein each one of the second dipoles disposed on a respective one of the plurality of first interlocking extensions and its another, corresponding one of the first plurality of second dipoles are arranged in a row on the first array face in an azimuth direction, and wherein each one of the second dipoles disposed on a respective one of the plurality of second interlocking extensions and its another, corresponding one of the second plurality of second dipoles are arranged in a row on the second array face in an azimuth direction.

12. The split sector antenna of claim 11,
wherein the first plurality of second dipoles are arranged on the first array face in a plurality of first rows along a vertical direction, and a number of the plurality of first rows have a single one of the first plurality of second dipoles and each of a remaining number of the plurality of first rows has one of the second dipoles disposed on a respective one of the plurality of first interlocking extensions and its another, corresponding one of the first plurality of second dipoles, and
wherein the second plurality of second dipoles are arranged on the second array face in a plurality of second rows along a vertical direction, and a number of the plurality of second rows have a single one of the second plurality of second dipoles and each of a remaining number of the plurality of second rows has one of the second dipoles disposed on a respective one of the plurality of second interlocking extensions and its another, corresponding one of the second plurality of second dipoles.

13. The split sector antenna of claim 12,
wherein the first plurality of first dipoles are arranged in a plurality of rows along the vertical direction on the first array face, and
where the second plurality of first dipoles are arranged in a plurality of rows along the vertical direction on the second array face.

14. The split sector antenna of claim 10, wherein the first azimuth angle and the second azimuth angle are of equal magnitude.

15. The split sector antenna of claim 12, wherein the first azimuth angle is -27 degrees relative to a mounting normal vector, and the second azimuth angle is +27 degrees relative to the mounting normal vector.

16. The split sector antenna of claim 10, wherein the first and the second array faces are disposed along the elevation axis with an offset relative to each other along the elevation axis.

17. The split sector antenna of claim 10, wherein the plurality of first and second interlocking extensions are configured to optimize a volume within the radome.

18. The split sector antenna of claim 10, wherein the plurality of first interlocking extensions and the plurality of second interlocking extensions are configured to interlink with each other.
